(19) United States
(12) Patent Application Publication
(10) Pub. No.: US 2011/0127221 A1
(43) Pub. Date: Jun. 2, 2011

(54) Method To Remove Toxic Heavy Metals

(75) Inventors: Sergio Gonzalo MONTES SOTOMAYOR, Estacion Central Santiago (CL); Jose Roberto Morales Pena, Nunoa Santiago (CL); Paulo Pogorelow Potaschkin, Nunoa Santiago (CL)

(73) Assignee: UNIVERSIDAD DE SANTIAGO DE CHILE, Estacion Central Santiago (CL)

(21) Appl. No.: 13/022,822

(22) Filed: Feb. 8, 2011

(30) Foreign Application Priority Data
Sep. 11, 2008 (CL) 2702-2008

(51) Int. Cl. C02F 1/62; C02F 1/28

(52) U.S. Cl. 210/668; 210/688

(57) ABSTRACT

A method to remove toxic heavy metals soluble in wastewaters of household or industrial origin that comprises the phases of:

Providing lignocellulosic material with low moisture (10% or less) which is subject to grading reduction with a size below 1 mm;

Defining a solid-liquid ratio in an adsorption reactor where its value depends on the liquid residue composition to be treated within a 3 and 50 g/L interval.

Placing the liquid to be treated and the lignocellulosic material in said adsorption reactor at room temperature.

Stirring and adjusting the pH value during the process, where said pH depends on the composition of the liquid residue to be treated. The pH value is adjusted within an interval of pH 3 through pH 8.

Keeping the liquid to be treated under turbulent stirring with the vegetal substrate inside the reactor until the concentration values desired for the metallic composition of the aqueous composition are achieved.

Use of lignocellulosic material of natural origin, such as wastes of timber and/or cellulose industry and agricultural industry, by-products of the forest industry, industry of grains to remove toxic heavy metals soluble in waste waters.

### CROSS REFERENCES TO RELATED APPLICATIONS

This application is a national phase application based upon priority International PCT Patent Application No. PCT/CL2009/000014 filed Sep. 11, 2009, which is based upon priority Chilean Patent Application No. 2702-2008 filed Sep. 11, 2008.

### FIELD OF THE INVENTION

The use of split lignocellulosic materials is proposed in order to eliminate toxic heavy metals soluble in wastewaters from household or industrial origin. The proper management of this technology involves defining the solid/liquid ratio or pulp density, the pH value at a constant or variable level and the stirring conditions in the adsorption reactor for each kind of RIL (liquid industrial waste), i.e. according to its chemical composition, which will allow optimizing the process in short periods of operation.

### BACKGROUND OF THE INVENTION

The presence of heavy metals soluble in wastewaters uses to be toxic for the flora and fauna including man. A number of sea plants and animals show a clear trend to bioaccrue metals in its different organs. Due to this, we may note in the bibliography that several methodologies have been developed to eliminate said metals. Among said technologies, chemical or biologic precipitation should be noted, which uses bacteria to reduce anion sulphates. Although precipitation/settlement or filtration are the methodologies mostly used at industrial level, they lose efficacy when dealing with very dilute solutions (U.S. Pat. No. 6,630,071 (2003); U.S. Pat. No. 5,080,806 (1992). Precipitates thus formed may be separated by settlement, filtration or flotation upon flocculation/coagulation if applicable. Since the precipitates formed, such as hydrated oxides or salts, depend on the solubility thereof, the concentrations remaining in the solution after the end of the process do not ensure that all metals may reach the maximum concentrations permitted by the regulations in effect in the different countries. The methods described above incorporate various amounts of new chemical and/or biologic contaminants (microorganisms) to the treated waters. Other methods use activated carbon and ionic exchange resins as adsorbing agents, which are frequently used at lab, pilot plant and industrial level scale, especially in this last case, when waters are to be softened (U.S. Pat. No. 6,878,286 (2005)). Due to its cost, however, regeneration is a necessary process and this increases the cost of the treatment process. A number of artificial chemical products deriving from hidroxyapatites (Bailliez, Doctoral Dissertation 03 ISAL 0007 (2003). Lyon, France) and natural products as bentonites, vermiculite and lignocellulosic materials has been studied to eliminate heavy metals from waters. The latter should be noted since their adsorbing capacity has been proved but under experimental conditions, which are not the most suitable to apply them at industrial level (Gaballah et Kibertus, J. of Geochem. Explor. 62 (1998)241-286). In the present invention this type of vegetal substrate is revalued to be used at lab scale and also at industrial level.

The adsorption processes are one of the few alternatives available in the market to eliminate metallic contaminants present in wastewaters, which concentrations may vary between μg/L and some tenths or hundredths of mg/L (Dubey et Gupta. Separation and Purification Technology. 41(1), 2005, 21-28). A number of investigations have been developed using low-cost natural adsorbing agents (Bailey. et al, Wat.Res. 33(11), 1999, 2469-2479) as tree bark, lignin, tannins, chitin, modified cotton, clays and zeolites among others. Tannins in particular are polyphenols, which are functionally similar to lignin that have been used as adsorbing agents of heavy metals. They are first reacted with aldehydes, such as formalin, and then precipitated with ammonia. Then, they are redissolved in the waters contaminated with heavy metals, which are precipitated again acting as adsorbing agents of heavy metals present in the contaminated water (U.S. Pat. No. 5,158,711; U.S. Pat. No. 5,460,791; U.S. Pat. No. 6,264,840).

Lignocellulosic materials are wide-ranging as to their origin, with the following having to be noted: wastes from the grain agricultural industry (walnuts, almonds, coffee, etc.) and tree bark, such as fir tree, acacia, pine and others, which behaviour has been studied by different researchers (Gaballah et al, WO 9215397; Palma et al, Wat. Res. 37(2003)4974-4980).

Lignocellulosic materials, as tree bark, have been recognized for decades as a material to adsorb heavy metals. The use and behavior of said materials for contaminated waters, however—both synthetic and natural—has become mostly restricted to the field of basic science.

### BRIEF SUMMARY OF THE INVENTION

The use of split lignocellulosic materials is proposed in order to eliminate toxic heavy metals soluble in wastewaters from household or industrial origin.

This invention shows several advantages relating to that already known in the state of the art. In this proposal:

1. Pre-treatment of chemical activation widely used in literature to date is eliminated, which incorporates chemicals in the preparation of the adsorbing vegetal substrate. This process increases the treatment cost of contaminated waters.

2. The presence of tannins soluble in treated waters is minimized due to the shortened adsorption times in the reactor. Tannins in fact form part of tree barks and have properties to adsorb heavy metals. Their extraction and use have been described in literature, but it involves additional costs by incorporating new chemicals as aldehydes and ammonia.

3. A rational use of the vegetal substrates already mentioned is made, which generally form part of agricultural industry wastes. This is achieved by applying certain operation conditions, which allows this kind of substrates to be revalued as adsorbing agents of heavy metals.

4. A restricted use of reactive chemicals is made, which makes the method ecologically and environmentally sustainable.

5. The treatment time in the adsorption reactor is significantly reduced with high efficiency in the elimination of heavy metals present in the water to be treated.

6. This can be applied to a multi-metallic system that may contain such metals as copper, zinc, nickel, lead, cadmium, cobalt, platinum, palladium, chromium, mercury, uranium and mixtures if the process is performed with proper solid-liquid ratio and pH values for the composition of waters.

7. The vegetal substrate obtained at the end of the process allows recycling in order to recover the heavy metals present in non-treated waters. This is an environment-friendly method.

A more detailed description of the invention is provided in the following description and appended claims taken in conjunction with the accompanying drawings.

### BRIEF DESCRIPTION OF THE DRAWINGS

FIG. 1 shows the particle size distribution of a grinding batch of radiata pine bark to be used, hereinafter called lignocellulosic adsorbing agent.

FIG. 2 shows the variation of copper concentration over time for a batch of copper sulphate synthetic solution (II) treated with lignocellulosic adsorbing agent.

FIG. 3 shows the variation of Copper, Zinc and Cadmium concentrations over time for a batch of copper nitrate synthetic solution (II), zinc sulphates (II) and cadmium nitrate (II) treated with lignocellulosic adsorbing agent where copper recovery is enhanced over other metals present in the solution by adjusting the process parameters.

FIG. 4 shows a general diagram of the process for the treatment of a solution batch for heavy metals by applying lignocellulosic materials, where numeric references show as follows:

(1) drying of lignocellulosic material

(2) grinding of lignocellulosic material

(3) filtering the heavy metals solution

(4) charging the reactor

(5) pH adjustment

(6) stirring

(7) filtering

(8) Are specifications met?

(9) reprocessing of metals and/or disposal of the lignocellulosic material used

(10) reuse of water or disposal at local level.

### DETAILED DESCRIPTION OF THE INVENTION

The following is a detailed description and explanation of the preferred embodiments and best modes contemplated by the inventors of carrying the invention along with some examples thereof.

The methodology proposed considers the use of natural renewable adsorbing agents without chemical treatment and defined as lignocellulosic, such as wastes from the grain industry (walnuts, almonds, peanuts, pistachio nut and coconut, among others), tree bark (pines in its different varieties as radiata, Douglas fir, eucalyptus, acacia, holm oak, rauli, oak tree, beech tree, among others). The method proposed optimizes the use of a vegetal substrate, which makes it possible the recycling process of the adsorbing agent and metals eliminated from wastewater, such as copper, zinc, nickel, lead, cadmium, cobalt, platinum, palladium, chromium, mercury, uranium and mixtures among others. The vegetal substrate with moisture equal to or below 10% should be reduced by grading to a size below 1 mm in a grinder prior to its use, so that to increase the solid-liquid interphase area in the reactor, which favors the efficacy of the adsorbing material. A proper solid-liquid ratio should be defined in the reactor within an interval between 3 and 50 g/L according to the initial metallic composition of wastewater. The process is conducted at room temperature. Prior to the batch process start-up, the working pH value should be adjusted, where said pH should range between pH 3 and pH 8, with this value depending on the metallic composition in the liquid residue. The vegetal substrate in the reactor may be found suspending or enclosed in containers permeable to the flow of liquid located inside the reactor. The vegetal material should be kept for the whole adsorption process under turbulent stirring where time—according to the composition of the original liquid residue—is within an interval of 0.5 and 2.0 hours—with a Reynolds value not below 4000 while the process is in progress. The concentration of heavy metals in the water should be monitored by using analysis techniques consistent with the concentrations of metals in the wastewater to be treated.

The different parameters characterizing the methodology proposed (pH, solid-liquid ratio, stirring, permanence times in the adsorption reactor, grading distribution of the raw material, temperature) should be simultaneously applied, which is not evident from the prior studies performed with lignocellulosic substrates.

### APPLICATION EXAMPLES

### Example 1

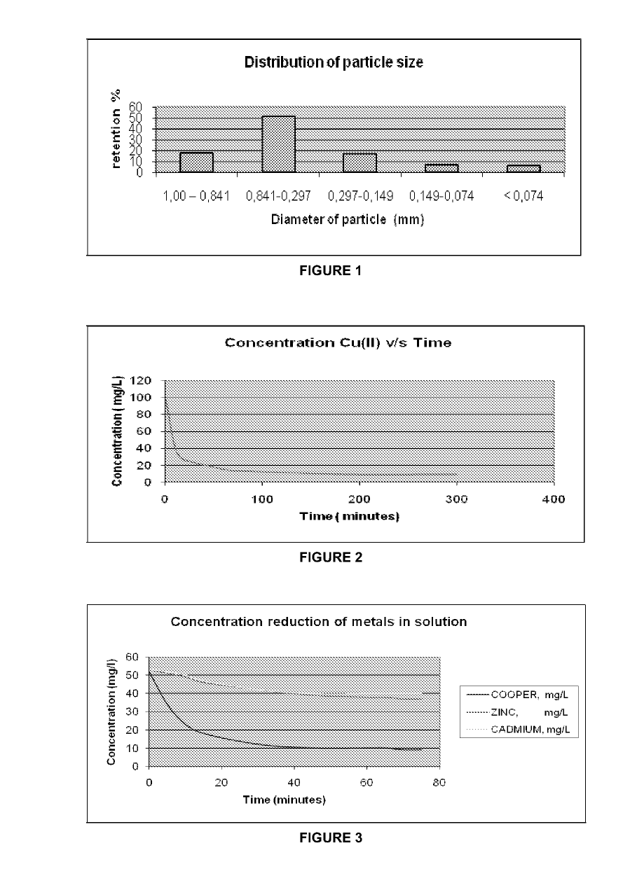

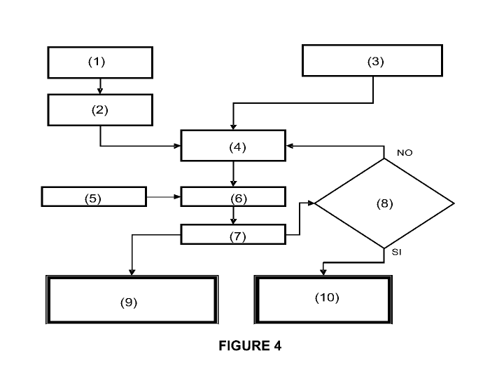

One liter of an aqueous solution of copper sulphates (II) of 100 mg Cu(II) concentration/liter was treated with 10 grams of radiata pine bark, 10% moisture, and a grading distribution below 1 mm of diameter. FIG. 1 shows the corresponding histogram. The suspension was mechanically stirred at 800 rpm keeping pH at a value of 5.5. FIG. 2 shows the adsorption kinetics from which it can be derived that after 1 h and 20 minutes the metal concentration in the aqueous phase was reduced by 87%. The experience was conducted at 19° C. The chemical analyses were performed by atomic absorption spectrophotometry.

### Example 2

Ten liters of an aqueous solution of copper nitrate (II) of 50 mg Cu(II) concentration/liter, zinc sulphate (II) at 50 mg concentration Zn(II)/liter and cadmium nitrate (II) at 50 mg concentration Cd(II)/liter, were treated with 100 grams of radiata pine bark, 10% moisture, and a grading distribution below 1 mm of diameter. FIG. 1 shows the histogram corresponding to the distribution of particle size of the lignocellulosic material used. The suspension was mechanically stirred at 700 rpm keeping pH at a value of 5.5. FIG. 3 shows the adsorption kinetics for Cu, Zn and Cd. The experience was conducted at 13° C. The chemical analyses were performed by atomic absorption spectrophotometry.

Although embodiments and examples of the invention have been shown and described, it is to be understood that various modifications, substitutions, and rearrangements of components, parts, materials, and method steps, as well as other uses of the invention, and other processes, can be made by those skilled in the art without departing from the novel spirit and scope of the invention.

1. A method to remove toxic heavy metals soluble in wastewaters of household or industrial origin, WHEREIN it comprises the phases of:
(a) Providing lignocellulosic material of natural origin with moisture equal to or below 10%, which is subject to grading reduction with a size below 1 mm;
(b) Defining a solid-liquid ratio in an adsorption reactor where its value depends on the liquid residue composition to be treated within a 3 and 50 g/L interval.
(c) Placing the liquid to be treated and the lignocellulosic material in said adsorption reactor at room temperature.
(d) Stirring and adjusting the pH value during the process, where said pH between 3 and 8 depends on the composition of the liquid residue to be treated.
(e) Keeping the liquid to be treated under turbulent stirring with the vegetal substrate inside the reactor until the concentrations values desired for the metallic composition of the aqueous composition are achieved.

2. A method to remove heavy metals according to claim 1, WHEREIN in phase (a) the grading reduction is conducted in a mill.

3. A method to remove heavy metals according to claim 1, WHEREIN in phase (c) the liquid to be treated and the lignocellulosic material is spread in the liquid phase.

4. A method to remove heavy metals according to claim 1, WHEREIN in phase (c) the liquid to be treated and the lignocellulosic material are enclosed in containers that are permeable to the aqueous flow inside the reactor.

5. A method to remove heavy metals according to claim 1, WHEREIN in phase (e) stirring is turbulent and it has a Reynolds number not below 4000.

6. A method to remove heavy metals according to claim 1, WHEREIN in phase (e) the variable time according to the composition of the original liquid residue is within a 0.5 to 2.0 hours interval.

7. Use of lignocellulosic material of natural origin, such as wastes of the timber and/or cellulose industry and agroindustry, by-products of forest industry, industry of grains WHEREIN it is useful to remove toxic heavy metals soluble in wastewaters.

8. Use of lignocellulosic material of natural origin according to claim 7, WHEREIN it can adsorb various metals such as copper, zinc, nickel, lead, cobalt, platinum, palladium, chromium, mercury, uranium and mixtures.

9. Use of lignocellulosic material of natural origin according to claim-87, WHEREIN said material adsorbs heavy metals with the capacity to adsorb and desorb metals in the solution according to the concentration of free hydrogen ions in the water.

10. Use of lignocellulosic material of natural origin according to claim 7, WHEREIN it exposes an elevated external surface according to the nature and chemical composition of the material.

11. Use of lignocellulosic material of natural origin according to claim 7, WHEREIN it can be used as heavy metals removing agents in RILES (liquid industrial wastes).

12. Use of lignocellulosic material of natural origin according to claim 7, WHEREIN said material has been subject to grading reduction with a size below 1 mm.

13. Use of lignocellulosic material of natural origin according to claim 7, WHEREIN the mass/volume ratio of the disperse lignocellulosic material in the wastewater varies between 3 and 50 g/L.

14. Use of lignocellulosic material of natural origin according to claim 7, WHEREIN the pH value is adjusted to an optimal variable value according to the RIL chemical composition.

15. Use of lignocellulosic material of natural origin according to claim 14, WHEREIN the pH value can be found in the 3.0 to 8.0 interval.
